(19) United States
(12) Patent Application Publication
(10) Pub. No.: US 2011/0306319 A1
(43) Pub. Date: Dec. 15, 2011

(54) Telephone Security System

(76) Inventor: Lee Sanft, Davie, FL (US)

(21) Appl. No.: 12/796,710

(22) Filed: Jun. 9, 2010

(51) Int. Cl. H04M 1/66

(52) U.S. Cl. 455/411; 379/188; 379/200

(57) ABSTRACT

Novel methods and devices for securing telephone access. A security code is associated with a phone number that is to be secured. A securing device that stores the security code is connected with the phone line of the phone number, and intercepts each calling to the phone number by requesting inputting of a security code and comparing the input code with the stored security code. The calls with a matching security code would be allowed to go through to the phone number's owner.

### BACKGROUND

The present application relates to phone access, and more particularly, to a novel method and device in providing telephone calling security.

Note that the points discussed below may reflect the hindsight gained from the disclosed application, and are not necessarily admitted to be prior art.

Unsolicited phone calls have become an annoying nuance to many people. Many frauds and crimes are conducted through the help of the easy access of a person's phone number. The most noticed examples are calls preying upon the elderly and calls soliciting credit numbers.

Variety of methods and devices have been devised to provide some level of security to phone calls. The most popular methods include displaying caller IDs, screening and blocking unwanted caller phone numbers, and subscribing to privileged caller list, etc.

However, almost all of the current methods require building a database of some sort by the user, either a caller ID database, a phone number database or a caller code database, and require comparing an incoming caller's ID or phone number with the pre-set caller ID database or phone number database. With people constantly moving and constantly changing of phone numbers, it is hard to keep an accurate caller ID list, which may render the phone screening devices non-useful by not allowing an allowed caller to call through.

For elderly, and people who are busy, it may be an impossible or tenuous task for them to constantly updating their phone screening devices. This makes the phone screening process and device expensive to keep and to use as they may need assistance from other people.

### SUMMARY

The present application discloses new approaches to phone access and security.

A security code will be associated with a phone number. Like the security code of a credit card, the security code of the phone number will not be published or known to people without the authorization of the owner of the phone number.

The owner then gives the security code to any one whom he or she would like to receive phone call from; and only the owner can change and cancel the security code.

In one embodiment, the security code may be generated by the phone company at the time of setting up a new phone service.

In another embodiment, the security code may be set on the phone service provider's server by the owner by using his online account of his phone service. One or more security codes may be set for different groups of callers.

In another embodiment, the security code may be set through a phone security device that is connected together with the phone.

The disclosed method, in various embodiments, eliminates the need to build phone number database by the user and dramatically simplifies the phone security system at minimum cost. Having a matchable level of security as to that provided by the credit card security code and being very simple to use and easy to maintain, especially for the elderly and people of much public attention, this simple method and system will provide a real level of security and control over the their own phones.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows an example of a user interface of the phone security device in accordance with this application.

FIG. 2 schematically shows an example of connection of a phone security device to the phone in accordance with this application.

FIG. 3 schematically shows an example of a user interface in setting a security code on the phone service provider's system in accordance with this application.

FIG. 4 schematically shows an example of process of receiving an income call in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that described method be applied to any applicable system, for example, a phone provider's server system, a user's answer machine, a sitting phone or a cellular phone; for clarity reason, the examples are given based on a separate security device, but an ordinary person in the art would know the variations and incorporate the method and device to other functional systems.

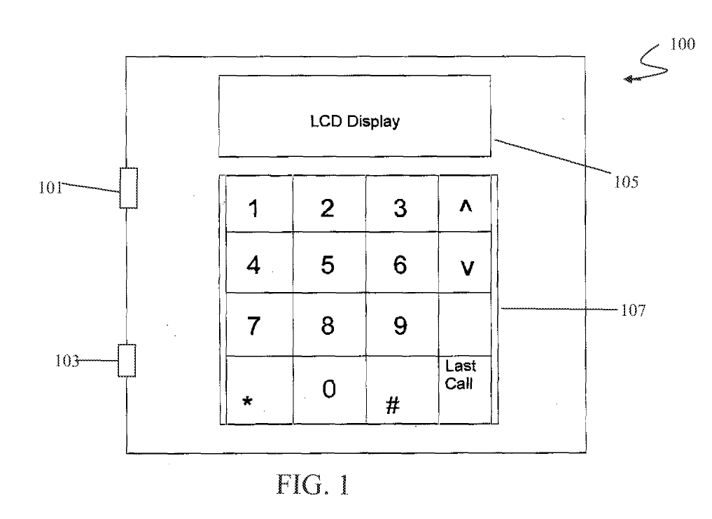

In reference to FIG. 1, which depicts the face panel of an example phone security device 100. Device 100 includes an input jacket 101 for connecting to, for example, a standard telephone wall jacket, and a phone jacket 103 for connecting to a phone. The user interface includes a LCD display 105 and a keypad 107 for inputting security code (s).

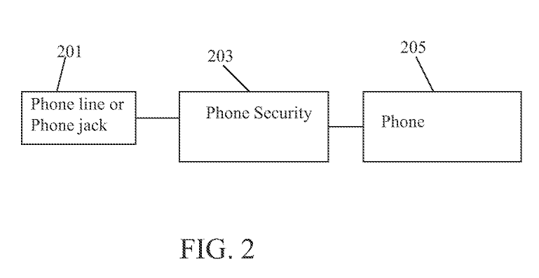

In reference to FIG. 2, to secure the access to phone 205, a phone security device 203, having the features of device 100 in FIG. 1, is connected with the phone. The input phone line 201 is connected via input jacket 101 of device 203 to device 203, and an output phone line, extending out from jacket 103 of device 203, connects with phone 205, which is supposed to have a limited access.

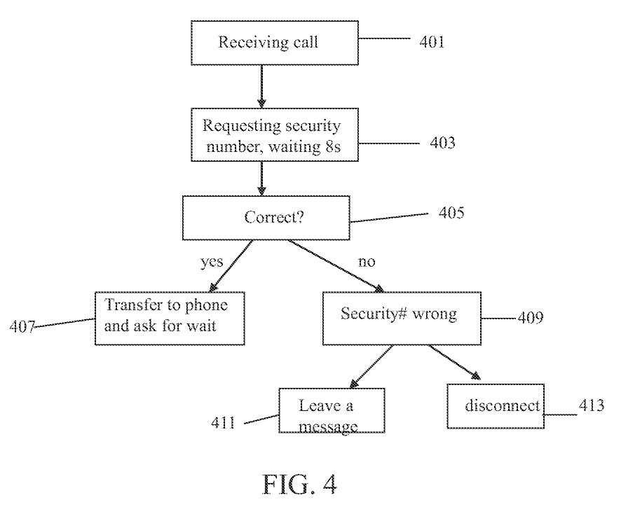

In reference to FIG. 4, device 100 includes a pre-programmed mirco-processor which performs the functions and features described in FIG. 4 and in the specification. Inputs from the user entered through keypad 107 and the input is monitored and displayed on display 105. The phone owner inputs a favored security code, for example, a three numeric code, and this code is then stored in a non-volatile memory.

For example, the owner entered “6, 4, 1” three digits when setting up the security device as the security code on the keypad. He then connected the device to his phone line. The device stored “6, 4, 1” as the security code for the connected phone line. It was connected in a way that an incoming call needed to go though the security device first as shown in FIG. 2.

When an incoming call is detected by processor at step 401, for example, by a ring detector module, similar to an answer machine, the processor activates a line seize module which seizes the incoming line, the equivalent of picking up the phone. The processor then activates a voice synthesizer at step 403 which plays the pre-recorded greeting which is transmitted via analog input/output module and the phone company's interface to the caller. A message such as “This line is secured. To continue, please enter the security code” would be transmitted to the caller. The processor then waits for a few seconds to receive a response.

As the caller enters the proper security code provided previously by the phone owner, the code would be decoded by a DTMF decoder according to the current telecommunication protocol, and sent to the processor of the security device. At step 405, the processor then compares this code with those saved in non-volatile memory to see if it matches to one of the codes pre-stored. For example, the caller retrieved the correct security code for this phone number to be “6, 4, 1” and entered “6, 4, 1” which matched to the owner pre-saved “6, 4, 1.” The processor would then reply with a message “Thank you, connecting . . . ” and activate a switch module which connects the caller with the phone at step 407.

If the processor does not receive a response within the preset time, it may repeat the request one or two times. If the processor does not receive a response after a few waiting times, or receives a wrong code, at step 409, that does not match the pre-stored code, the processor may either terminate the call at step 413 or activate the switch to an answering machine module/device at shown at step 411.

The features and functions described in FIGS. 1 and 4 may be directly implemented on a phone or a cellular phone set.

Alternatively, the features and functions described in FIGS. 1 and 4 can be implemented on a phone service provider's server.

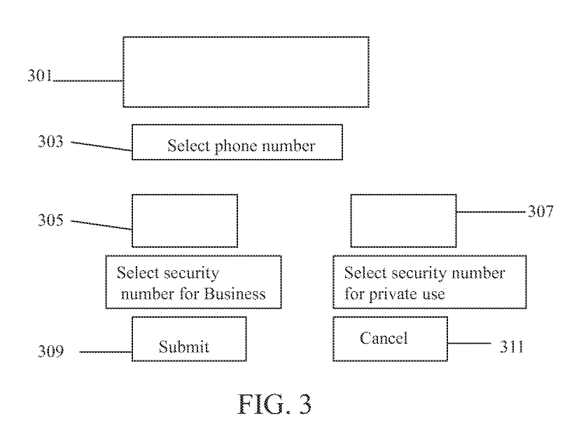

IN reference to FIG. 3, a telephone service provider on its server system provides a user interface similar to FIG. 3, and corresponding functions and features similar to FIG. 4. Either a phone service operator or the owner of the phone number can login to a user interface associated with a phone number to be secured.

The interface contains an input box 301 for inputting the phone number in concern, button 303 for submitting phone number to the server; input boxes 305 and 307 represent different security codes for different groups of callers. Button 309 would submit all the inputs to the phone company's server and save them in its database. Button 311 can cancel security code service if needed.

Once a phone number is associated with a security code on the server of the phone service provider, the server can perform the checking and matching as described previously above before sending the calling to the phone number owner's phone. People who do not have the correct security code would be turned away to a voice box or be disconnected by the phone server.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publications, all of which are hereby incorporated by reference herein for all purposes: U.S. Pat. Nos. 4,488,005, 4,926,470, 5,033,076, 5,912,948, 6,456,706, 6,549,619, 6,680,935, 7,027,569, 7,155,001, 7,162,019.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method for securing a telephone number, comprising the actions of:
associating the telephone number with at least one security code;
providing said security code to authorized callers; and
requesting security code from an incoming calling.

2. The method of claim 1, wherein the action of associating the telephone number with security code is performed with a standalone device.

3. The method of claim 1, wherein the action of associating the telephone number with security code is performed with a phone set.

4. The method of claim 1, wherein the action of associating the telephone number with security code is performed with a cellular phone.

5. The method of claim 1, wherein the action of associating the telephone number with security code is performed by a phone service provider.

6. The method of claim 1, wherein the action of associating the telephone number with security code comprises associating plurality of security codes, wherein each code represents a different group of callers.

7. The method of claim 1, further comprising the action of switching to an answering function as the result of matching an incoming security code input with said security code.

8. A telephone security device, comprising:
a first device module for storing at least one security code for a telephone number;
a second device module for requesting an input security code from an incoming calling of the telephone number;
a third device module for comparing the input security code with at least one said stored security code of the telephone number; and
a fourth device module for switching the incoming calling, wherein said first, second, third and fourth device module are electronically connected and controlled by a computer processor.

9. The device of claim 8 is a standalone device.

10. The device of claim 8 is part of a phone set.

11. The device of claim 8 is part of a central server of a phone service provider.

12. The device of claim 8, wherein said first, second, third, and fourth device communicates with each other via the internet.

13. The device of claim 8, wherein at least one device module communicates wirelessly to other modules.
